(19) United States
(12) Patent Application Publication
(10) Pub. No.: US 2023/0117025 A1
(43) Pub. Date: Apr. 20, 2023

(54) PUBLIC SAFETY COMMUNICATION SYSTEM and METHOD PROVIDING REGIONAL DIFFERENCE RECOGNITION

(71) Applicant: MOTOROLA SOLUTIONS, INC., Chicago, IL (US)

(72) Inventors: PRATEEK PRADEEP, PLANTATION, FL (US); JODY H AKENS, WESTON, FL (US); GIORGI BIT-BABIK, PLANTATION, FL (US); THOMAS J JOYCE, BOYNTON BEACH, FL (US)

(21) Appl. No.: 17/449,716

(22) Filed: Oct. 20, 2021

(51) Int. Cl. G06V 40/20; G08B 21/02; H04N 7/18; G06V 20/40; G10L 25/63; G10L 25/57

(52) U.S. Cl. CPC G06V 40/20; G08B 21/02; H04N 7/183; G06V 20/40; G10L 25/63; G10L 25/57

(57) ABSTRACT

A communication system operating within a public safety network includes a cultural analytics engine configured to receive a video feed from a security camera system or a portable public safety communication device operating within the system. The cultural analytics engine performs primary aggressive behavior video analytics detection on the video feed to detect potential aggressive behavior within the video feed. The analytics engine further performs secondary cultural exception analytics on the video feed to determine whether a cultural exception to the behavior is detected. Audio verification is performed on identified potential exceptions. In response to no cultural exception being detected, an alert is generated indicative of a public safety incident, and in response to a cultural exception being detected, no alert is sent

### BACKGROUND OF THE INVENTION

Public safety communication systems are increasingly incorporating video and audio analytics into various facets of their systems resulting in large amounts of video and audio data being available. However, public safety personnel may be challenged by the variety of video and audio sources, particularly when responding to potential incidents taking place in regions where cultural behaviors may differ from a population norm or differ from one culture to another. The lack of regional context may also result in false incident triggers. The reliance of current systems on traditional incident triggers may not be well suited or applicable to the analytics needed for today's culturally diverse populations and geographically varied regions. The lack of cultural differentiators within the accessed information may create false alerts as a result of incident triggers based on behaviors perceived as being unacceptable in one culture or region and acceptable in another culture or region.

Accordingly, there exists a need for a public safety communication system which facilitates identifying incident triggers while being mindful of regional and cultural differentiators to minimize false triggers.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system block diagram illustrating a communication system in accordance with some embodiments.

FIG. 2A is a flowchart of a method for identifying cultural aspects in accordance with some embodiments.

FIG. 2B is a flowchart of a sub-section of FIG. 2A for identifying cultural aspects in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Briefly, there is provided herein, a system and method for minimizing false incident triggers within a potential incident scene. The embodiments provide for a cultural analytics engine or server incorporated within a communication system which can be dynamically updated and expanded upon by linking to various regional databases throughout the world. The cultural analytics engine facilitates generating appropriate incident alerts with an improved understanding of cultural behaviors which may be taking place. The cultural analytics engine focuses on defining body gestures within different cultures, and is directed to identifying which gestures are hostile and which gestures are non-hostile within these different cultures. The cultural engine includes video and audio analytics for determining potentially hostile or aggressive gestures, and filtering out gestures which are considered acceptable within a cultural norm. The cultural analytics engine generates an alert when hostile or aggressive gestures are detected. The detection is based on contextual parameters analyzed by the engine within the video feeds and audio streams.

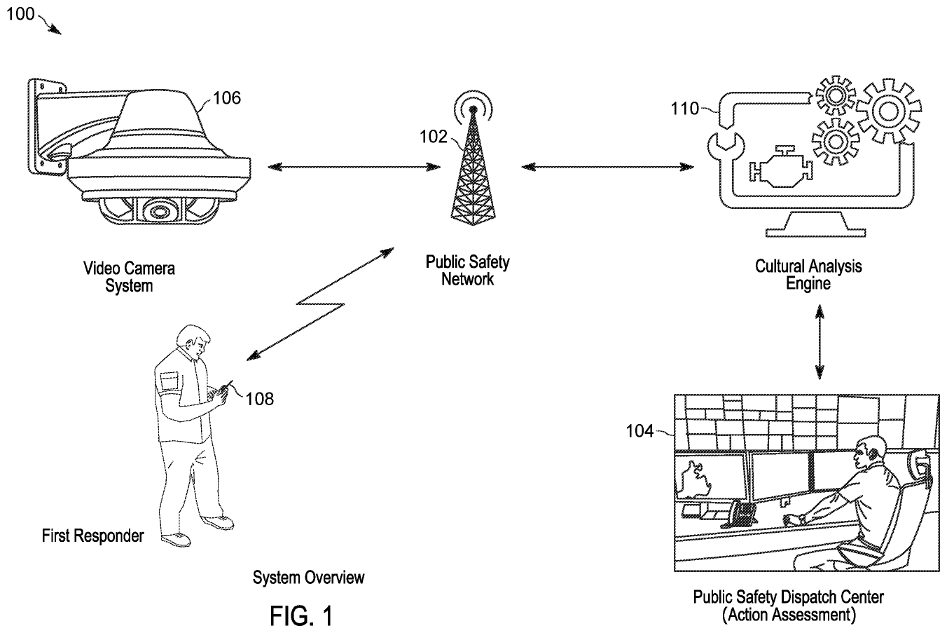

FIG. 1 is a system block diagram illustrating a communication system 100 formed in accordance with some embodiments. FIG. 1 is a system block diagram illustrating a communication system for identifying cultural aspects at an incident or potential incident in accordance with some embodiments. Communication system 100 comprises a public safety network 102 interoperable with a command central station 104, such as a dispatch station, a security camera system 106, one or more portable public safety communication devices 108 operated by one or more first responders, and a cultural analytics engine 110. The security camera system 106 may comprise for example plurality of high definition video cameras, motion sensors, and microphone arrays so acquiring video and audio data streams. The one or more portable public safety communication devices 108 comprise at least a public safety radio 112, and may further comprise, for example, a body worn remote speaker microphone (RSM) with body cam capability, a tablet with video and audio recording capability, and/or a cell phone with video and audio recording capability, to name a few. For the purposes of this application, the command central station 104, security camera system 106, the one or more portable public safety communication devices 108, and the cultural analytics engine 110 are able to communicate with the public safety network 102 using communication technologies, known or yet to be developed. In accordance with the embodiments, the command central station 104, security camera system 106, and the one or more portable public safety communication devices 108 acquire video and audio streams from potential incident scenes and upload the streams, via the public safety network, to the cultural analytics engine 110. The cultural analytics engine 110 may be a server, cloud based or wired, that uses machine learning algorithms to perform cultural analytics on the data streams.

In accordance with the embodiments, the cultural analytics engine 110 receives the video and audio streams from the source devices responding to potential incident scenes. The potential incident scenes video may be initially acquired by the video camera system detecting movement or sound, the first responder performing a video recording. The command central station 104 may also trigger remote cameras (security or body worn) to acquire video in response to an incoming call, or detection by one of the systems of a potential incident.

Periodic acquisition of video may also be uploaded to the cultural analytics engine for baseline analytics. For example, data mining cultural behavior videos (private and public videos) may be uploaded and stored within a cultural reference database of the cultural analytics server including cultural behavior and cultural activities with cross referenced keywords embedded therein associated with the cultural behavior and cultural activities. The data mining performed by the analytics engine may further comprise identifying a geographic region having a diverse culture and identifying cultural data parameters and audio parameters associated with that diverse culture, identifying different geographic regions having non-diverse culture and identifying cultural data parameters and audio parameters for the non-diverse culture.

The acquired video streams are uploaded to the cultural analytics engine 110 where image and audio processing take place to learn cultural aspects and build up a database of cultural awareness. The cultural analytics engine 110 includes a controller, transceiver, and artificial intelligence, and a memory database. The cultural analytics engine utilizes machine learning algorithms described herein to detect differences in human interaction based on cultural context and to build a database that allows for quick identification of hostile or non-hostile behaviors based on cultural context. The system and method avoid false alarms of either hostile or non-hostile behavior. The cultural context entails actions and activities that take place in different cultural regions which can then be applied to other cultural regions.

The security camera system 106 may form part of a smart city camera system that provides a subscription based fee for operation and access to the analytics.

Different cultural aspects may occur within a same geographical location or at different geographical location, and the ability avoid false triggers on perceived hostile behavior The following two use cases are provided as examples:

Diverse cultures in different regions. In countries such as the United States, Canada, and Great Britain, there are large diversity and cultural aspects within each country's respective population. In these geographic locations, the results from image processing technology may mistake an interaction between two or more people as a hostile interaction or as a friendly interaction. For example, in some Asian cultures young people may greet each other in what might be considered an aggressive manner, appearing as though person A is trying to choke person B from behind. This cultural interaction may create a false alarm in current video analytics systems used in the geographic regions of United States, Canada, and Great Britain, because the analytics were designed to cater to a majority of the population who do not greet each other in the same manner as young Asians. The cultural analytics engine 110 beneficially identifies the geographic region (as USA, Canada or Great Britain) and the cultural behavior as an exception to that geographic region. The exception is determined based on a plurality of analytical factors including cultural ceremony, time of day, week, month, ethnicity of the behavior (does the behavior match with a known ethnic behavior). Once an exception is determined, further audio analytics can be performed to further ensure that the detected behavior falls within the culturally accepted norm, and the system can return to regular acquisition and periodic uploads until another trigger is detected.

Different location with new culture—When video surveillance technology, either from body cameras, wall mounted camera or some other source, is installed in a new country, a use case may arise where rituals and activities performed by locals can be misconstrued as hostile activity. For example, during a birthday celebration in India, a birthday boy being gently kicked on his rear by his friends, totaling to his age is considered traditional cultural behavior for that region. Similar unconventional rituals in China and other countries are performed, such as celebration of Muharram in Islamic religion. These rituals might be considered an act of hostility or aggression, which would trigger a false alarm in the system in that country.

This cultural interaction may create a false alarm in current video analytics systems used in the geographic regions of India, because the analytics were designed to cater to a majority of the population in (USA, Canada Great Britain) Again, the cultural analytics engine 110 beneficially identifies the geographic region (India) and the cultural behavior is considered a norm for that region. Additional safety filters can be added and removed to the cultural analytics engine depending on the region in which the system is located. Thus the cultural engine is highly adaptable to different regions which minimize false alarm alerts.

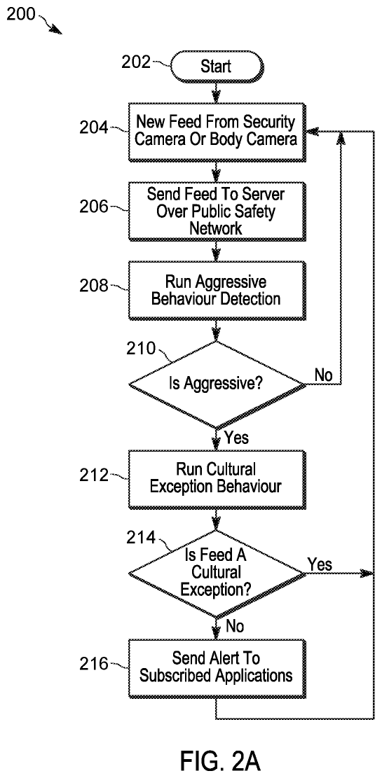

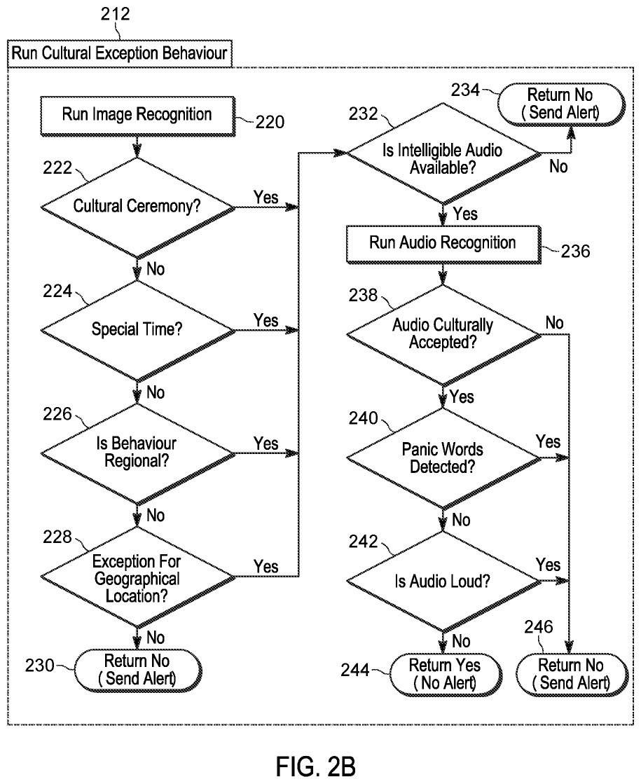

FIG. 2A is a flowchart of a method 200 for identifying cultural aspects in accordance with some embodiments. The method begins at 202 with acquiring a video feed within a geographic region by a public safety communication device operational within a public safety network, such as provided in FIG. 1. The communication device may comprise, for example. a fixed security camera operating within a public safety network, a subscription based smart city camera operating within the public safety network, a portable communication device having recording capability, a body worn camera, vehicle dash-cam, and the like, where such devices are capable of uploading video feeds and audio streams through the public safety network.

The acquired video feed is sent at 206 through the public safety network to a cultural analytics server, the cultural analytics server being coupled, wired or wirelessly to the public safety network and command central station. At 208, the cultural analytics runs behavior detection by performing primary aggressive behavior video analytics detection on the video feed. The analytics may be based on gesture within the video feed. If potentially aggressive behavior is detected within the video at 210, then the cultural analytics server performs a secondary cultural exception analytics on the video feed containing the potential aggressive behavior at 212 which then determines at 214 whether a cultural exception to the behavior is detected.

When no cultural exception is detected at 214, (i.e. the behavior is indeed considered to be outside of a cultural regional norm) the cultural analytics engine, generates a positive alert at 216 indicative of a potential public safety incident based on the detected aggressive behavior. Once the alert is sent, the method resumes by returning to 204 where additional video feeds are acquired by devices and processed through the analytics engine. The alert may be sent, over the public safety network, to a command central station and to public safety personnel associated with the acquired video feed. The analytics engine may further send recommendations for response actions associated with the aggressive behavior.

When a cultural exception is detected at 214, (i.e. the behavior is within the regional norm) the method can simply return to auguring and analyzing new feeds, without sending any alert. The method may further identify the cultural exception to the public safety communication device associated with the video, so that the public safety personnel are aware of the cultural exception.

The cultural analytics engine may, in some embodiments, in response to a cultural exception being identified at 214, analyze further sub-categories (ceremonies, time of day, time of year, dialect) of the exception to ensure that no public safety incident is taking place. For example, what appears to be an exception (cultural norm) behavior occurring at a geographic location may be the norm for only a certain time of year and not others. The analytics engine can further refine analysis of the exception (i.e. the norms) to ensure that an actual public safety incident is not misidentified as a norm.

FIG. 2B is a flowchart of a sub-section of FIG. 2A for identifying cultural exception behaviors in accordance with some embodiments. The analytics are being performed on the detected aggressive behavior at 212/214 are expanded upon in this flowchart. Beginning at 220, the cultural behavior engine of FIG. 1 runs image recognition analytics to determine if the detected potentially aggressive behavior is associated with one or more predetermined cultural parameters.

Determining if the detected potentially aggressive behavior is associated with one or more predetermined cultural parameters may include, for example, determining if the detected behavior is taking place as part of a cultural ceremony 222, determining if the detected behavior is taking place at particular time of year 224, determining if the detected behavior is associated with a regional tradition 226, and/or if the detected behavior is taking place at a geographic location considered to be an exception at 228 to such behavior. If the detected behavior does not meet any of the predetermined cultural parameters then an alert will be generated by the server and transmitted over public safety network at 230 to devices associated with public safety personnel (dispatcher, or personnel associated with acquiring the video) alerting them that the aggressive behavior has no cultural exception associated therewith, so that appropriate action can be taken. For video originating from security cameras, the alerts will be transmitted to a dispatcher/command central station so that local public safety personnel in the vicinity of the camera can be alerted to the incident.

If the image recognition analytics determines that the detected potentially aggressive behavior is associated with one or more of the predetermined cultural parameters, then a check is made for intelligible audio at 232 within the acquired stream. If intelligible audio is not available, then an alert will be generated at 234. Thus, the cultural behavior analytics engine relies on both video and audio analytics to ensure that only viable exceptions to sending an alert are permitted.

If intelligible audio is available, then audio analytics are run at 236 to determine if the acquired audio associated with the detected potentially aggressive behavior is associated with one or more predetermined audio parameters. Determining if the detected potentially aggressive behavior is associated with one or more predetermined audio parameters may include, for example, determining if the audio associated with the potentially aggressive behavior is culturally accepted at 238, checking for the presence of panic trigger words at 240, and/or detecting loudness or aggressiveness of the audio at 242.

Determining if the audio associated with the potentially aggressive behavior is culturally accepted at 238, may include for example, determining if the audio is acceptable for the type ceremony, time, region and/or geographic location which were initially identified by the video analytics. If the audio is not culturally accepted at 238, then an alert will be generated at 246. If the audio is acceptable, then the method proceeds to 240 to check for panic words.

Determining if the audio includes panic words at 240 may include, for example, detecting predetermined trigger words such as “fire”, “burn”, “help”. If any such words are detected in any language in an audio stream, the cultural analytics server will generate an alert at 246. If no such panic words are detected, then the method proceeds to check for audio loudness at 242.

Determining if the audio associated with the potentially aggressive behavior is loud at 242 may include comparing the audio to a predetermined audio loudness threshold. The threshold level of loudness can be adjusted based on the type ceremony, time, region and/or geographic location which were initially identified by the video analytics. If a loudness threshold is breached, then an alert is generated at 246. If the loudness threshold is not breached at 242, then no alert is sent at 244.

Accordingly, there has been provided a system and method which facilitate identifying potential cultural aspects to minimize false alerts under culturally acceptable predetermined parameters. The video and audio cultural parameters are adjustable so that the system can adapt to different regions of different cultures.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication system, comprising:
a public safety network interoperable with a command central station, a plurality of public safety communication devices, and a cultural analytics engine; and
a cultural analytics engine interoperable with the public safety network, the cultural analytics engine having a controller configured to:
receive a video feed from at least one of the plurality of public safety communication devices;
perform primary aggressive behavior video analytics detection on the video feed;
detect potential aggressive behavior within the video feed;
perform secondary cultural exception analytics on the video feed containing the potential aggressive behavior to determine whether a cultural exception to the potential aggressive behavior is detected;
in response to no cultural exception being detected, generate an alert indicative of a potential public safety incident; and
in response to a cultural exception is detected, not sending an alert.

2. The communication system of claim 1, wherein the primary aggressive behavior video analytics detection is based on based on gesture.

3. The communication system of claim 2, wherein the secondary cultural exception analytics is based on:
predetermined cultural parameters detected within the video feed; and
predetermined audio parameters detected in an audio stream associated with the video feed.

4. The communication system of claim 3, wherein the predetermined cultural data parameters comprise at least one of:
cultural ceremony, time, regional tradition, and geographic location.

5. The communication system of claim 4, wherein the predetermined audio parameters comprise at least one of:
audio being culturally accepted, trigger words, and audio loudness.

6. The communication system of claim 1, wherein the plurality of public safety communication devices comprises at least one security camera operable within the public safety network.

7. The communication system of claim 1, wherein the plurality of public safety communication devices comprises at least one subscription based smart city camera.

8. A method, comprising:
acquiring a video feed within a geographic region at a public safety communication device within a public safety network;
sending the video feed to a cultural analytics engine of the public safety network;
performing primary aggressive behavior video analytics detection on the video feed;
detecting potential aggressive behavior within the video feed;
performing secondary cultural exception analytics on the video feed containing the potential aggressive behavior to determine whether a cultural exception to the behavior is detected; and
in response to no cultural exception being detected generate an alert indicative of a potential public safety incident; and
in response to a cultural exception being detected, not sending an alert.

9. The method of claim 8, wherein the primary aggressive behavior video analytics detection is based on based on gesture.

10. The method of claim 8, wherein the secondary cultural exception analytics are based on:
predetermined cultural parameters detected within the video feed; and
predetermined audio parameters detected in an audio stream associated with the video feed.

11. The method of claim 8, wherein performing secondary cultural exception analytics further comprises:
performing image recognition on the video feed associated with the detected potential aggressive behavior;
determining at least one predetermined cultural parameter within the video feed;
determining that intelligible audio is available for audio analytics to be performed;
performing audio analytics on an audio stream associated with the detected potential aggressive behavior;
determining at least one predetermined audio parameter within the audio stream; and
generating an alert when the audio analytics do not indicate a cultural exception.

12. The method of claim 11, wherein the predetermined cultural data parameters comprise at least one of:
cultural ceremony, time, regional tradition, and geographic location.

13. The method of claim 11, wherein the predetermined audio parameters comprise at least one of:
audio being culturally accepted, predetermined trigger words, and audio loudness above a predetermined threshold.

14. The method of claim 8, wherein the public safety communication device comprises at least one of:
a security camera operable within the public safety network;
a body worn camera operable within the public safety network; and
in-vehicle dash camera operatively operable within the public safety network.

15. The method of claim 8, wherein the public safety communication device comprises a subscription based smart city camera.

16. The method of claim 8, further comprising:
data mining cultural behavior videos into a cultural reference database of the cultural analytics engine including cultural behavior and cultural activities with cross referenced keywords.
